(19) United States
(12) Patent Application Publication
(10) Pub. No.: US 2013/0222418 A1
(43) Pub. Date: Aug. 29, 2013

(54) Providing a Graphic for Video Production

(71) Applicants: Timothy D. Campbell, Lexington, KY (US); Gerald Geurkink, Lexington, KY (US); David Rhodus, Richmond, KY (US)

(72) Inventors: Timothy D. Campbell, Lexington, KY (US); Gerald Geurkink, Lexington, KY (US); David Rhodus, Richmond, KY (US)

(73) Assignee: IHIGH.COM, INC., Lexington, KY (US)

(21) Appl. No.: 13/404,389

(22) Filed: Feb. 24, 2012

(51) Int. Cl. G09G 5/00

(52) U.S. Cl. 345/629

(57) ABSTRACT

Included are embodiments for providing a graphic for a video production. Some embodiments include capturing video data of an event, identifying a participant that is participating in the event, and receiving participant data from a performance social networking page of the participant. Additionally, some embodiments may include determining an act of interest in the event that involves the participant, retrieving from the multi-tiered performance social network, participant data about the participant, and creating a graphic within the video data that includes at least a portion of the participant data. Some embodiments include broadcasting the video data with the graphic to a plurality of viewers.

### BACKGROUND

1. Field

Embodiments provided herein generally relate to providing a graphic for a video production, and particularly to utilizing statistical data from a social network for use in a video graphic for a video production.

2. Technical Background

As a background, many broadcasters, such as sports broadcasters, theatrical broadcasters, news broadcasters, entertainment broadcasters, etc. desire to provide video production and broadcasting of sporting events and/or other events to viewers. As such, the broadcasters may capture video data from the event. The video data may then be sent via a production computing device to a remotely located studio, where editing and/or other production features may be implemented. The production features may include selecting a desired camera to broadcast; adding graphics; adding voiceover; etc. From the remotely located studio, video production may then be broadcast to viewers.

While such current solutions may provide a portion of the desired production features, the costs, administrative overhead, and manpower required to implement such a system may be overwhelming for many broadcasters. Additionally, the logistics for operating a multi-location production team may also be difficult,

### SUMMARY

Included are embodiments for providing a graphic for a video broadcast. In some embodiments a method may include capturing video data of an event, identifying a participant that is participating in the event, and receiving participant data from a social networking page of the participant. Additionally, some embodiments may include determining an act of interest in the event that involves the participant, retrieving from the multi-tiered social network (such as a multi-tiered performance social network and/or a general multi-tiered social network), participant data about the participant, and creating a graphic within the video data that includes at least a portion of the participant data. Some embodiments include broadcasting the video data to a plurality of viewers.

Also included are embodiments of a system. Some embodiments of a system include a memory component that stores logic that, when executed by the system, causes the system to receive a live video of an event, the event involving a participant, determine a point of action in the event, and receive an indication for inserting a graphic overlay in the live video, the graphic overlay identifying the participant. In some embodiments, the logic further causes the system to access a participant profile page of the participant from a social network to retrieve a performance statistic of the participant, include the performance statistic in the graphic overlay. Similarly, in some embodiments the logic causes the system to broadcast the live video and the graphic overlay to a plurality of viewers.

Still some embodiments include a non-transitory computer-readable medium that stores logic that, when executed by a computing device, causes the computing device to receive a live video of a sporting event, the sporting event involving a plurality of teams, the plurality of teams each including a participant. The logic may additionally cause the computing device to determine a point of action in the sporting event and receive an indication for inserting a graphic overlay in the live video, the graphic overlay identifying the participant from at least one of the plurality of teams. In some embodiments, the logic causes the computing device to access a participant profile page of the participant from the at least one of the plurality of teams, include the performance statistic in the graphic overlay, and broadcast the live video and the graphic overlay to a plurality of viewers.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for providing a graphic for a video production, according to one or more embodiments shown and described herein;

FIG. 2 depicts a production computing device for providing a graphic for a video production, according to one or more embodiments shown and described herein;

FIG. 3 depicts a user interface for providing a group page on a performance social network, according to one or more embodiments shown and described herein;

FIG. 4 depicts a user interface for providing a roster of participants, according to one or more embodiments shown and described herein;

FIG. 5 depicts a user interface for providing a participant profile, according to one or more embodiments shown and described herein;

FIG. 6 depicts a user interface that provides a participant profile in a performance social network, according to one or more embodiments shown and described herein;

FIG. 7 depicts a user interface that provides a production portal for producing one or more events, according to embodiments shown and described herein;

FIG. 8 depicts a user interface for selecting and/or editing production templates of a broadcast, according to embodiments shown and described herein;

FIG. 9 depicts a user interface for editing a pre-game production template, according to embodiments shown and described herein;

FIG. 10 depicts a user interface for editing an in-game production template, according to embodiments shown and described herein;

FIG. 11 depicts a user interface for editing a post-game production template, according to embodiments shown and described herein;

FIG. 12 depicts a user interface for providing a graphic for a video production, according to embodiments shown and described herein;

FIG. 13 depicts a user interface for providing a graphic for a video production, according to embodiments shown and described herein;

FIG. 14 depicts a user interface that depicts a graphic that is included in a video production, according to embodiments shown and described herein;

FIG. 15 depicts a user interface that provides additional options for providing a graphic for a video production, according to embodiments shown and described herein; and

FIG. 16 depicts a flowchart for providing a graphic for a video production, according to embodiments shown and described herein.

### DETAILED DESCRIPTION

Accordingly, embodiments disclosed herein may be utilized to receive video data for an event, such as a sporting event, theatrical event, entertainment event, news event, scholastic event, business event, etc. Additionally, the embodiments disclosed herein may access a social network that includes participant profiles. In some embodiments, the participant profiles are included within group profiles. As an example, the social network may include a “team profile page” for a soccer team. The team profile page may include pictures of players, statistics, schedules, leagues, and/or other data. By selecting one of the players, the social network may navigate a user to a profile page for that player. Depending on the particular embodiment, the player may administer at least a portion of his/her own player profile page. In some embodiments, the player may provide quotations, pictures, etc. for his/her profile page. Statistics, schedules, and/or other information may be provided by the administrator of the team page and/or other entity.

Accordingly, the embodiments disclosed herein may have access to the social network team page of the teams that are participating in the performance that is being broadcast. If a player on one of those teams scores a goal, the production computing device operator can identify a player (e.g., inputting Team A, player 13) into a user interface. Embodiments disclosed herein may access the social network to identify the player, retrieve statistical information for the player and/or team, and provide the information for inclusion into the video production.

The information retrieved from the social network may then be utilized as a graphic on the broadcast so that viewers are made aware of the player that scored the goal, as well as the other information. Similarly, at halftime and/or after the event, embodiments described herein may identify a highlighted participant of the event, based on in-game statistics and/or other criteria. The in-game statistics may be determined from the production computing device user's actions, from a scoreboard output, and/or from a video recognition. As the statistics are compiled (and/or after the event), the statistics, imagery, and/or other data may be sent back to the social network to update the team profile page and/or the player profile page.

Additionally, in some embodiments, the production computing device user may utilize a template for performing these actions. As an example, if the production computing device user is broadcasting a horse show, the production computing device operator may utilize a template for the horse show, which will provide information as desired for that type of event. A different template may be used for different types of events. The template may also be utilized for providing criteria to determine a participant of the game, which in game statistics to provide, and/or other information.

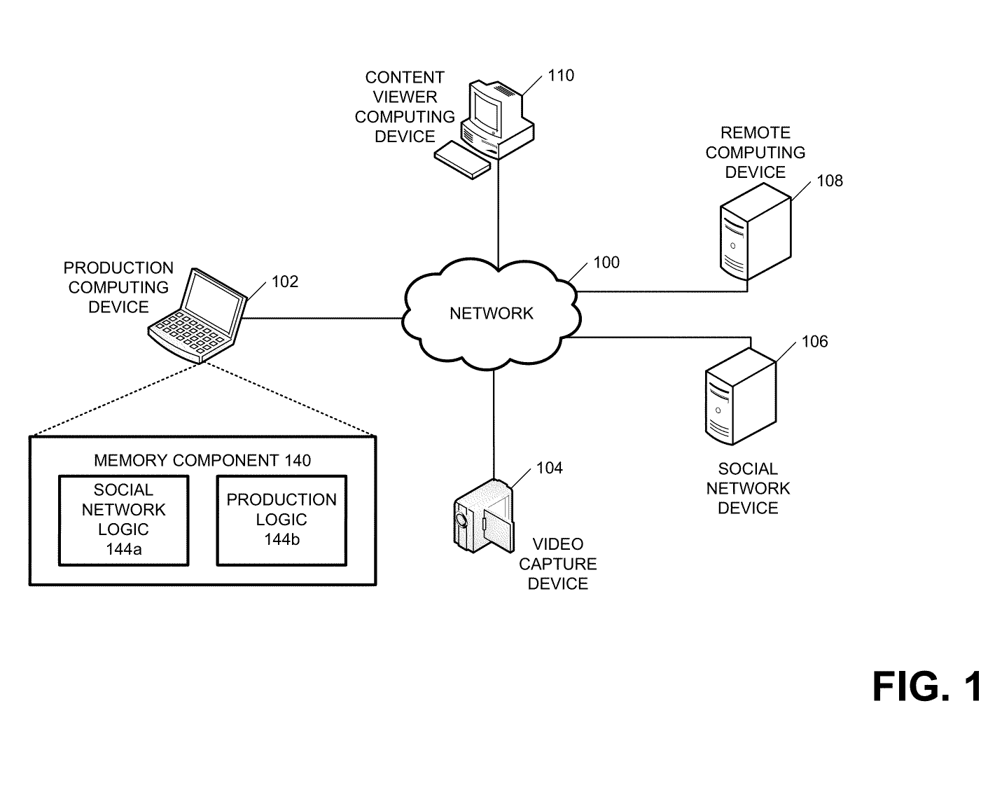

Referring now to the drawings, FIG. 1 depicts a computing environment for providing a graphic for a video production, according to one or more embodiments shown and described herein. As illustrated in FIG. 1, a network 100 may include a wide area network, such as the Internet, a local area network (LAN), a mobile communications network, a satellite network, a public service telephone network (PSTN) and/or other network and may be configured to electronically couple a production computing device 102, a video capture device 104, a social network device 106, a remote computing device 108, and a content viewer computing device 110.

The production computing device 102 may include a memory component 140. The memory component 140 may include social networking logic 144a and production logic 144b. The production computing device 102 may receive video data of an event from the video capture device 104. The video capture device 104 may include one or more video cameras, sensors, microphones, speakers, and/or other devices for capturing video and/or audio data for the event and communicating that data to the production computing device 102.

Once (or in some embodiments before) the production computing device 102 receives the video data, the production computing device 102 may access statistical and/or other data from the social network device 106. The social network device 106 may be configured as one or more devices for providing the social network, as described herein. Additionally, the production computing device 102 may be configured to update the statistical data that is maintained by the social network device 106, based on actions of the event.

As the production computing device 102 is producing the video, the production computing device 102 may broadcast the video production to one or more viewers. In some embodiments, the production computing device 102 may broadcast the video via a satellite to a broadcast television. Similarly, in some embodiments, the production computing device 102 may send the video to the social network device 106 for online access of the video. In still some embodiments, the production computing device 102 may send the video to the remote computing device 108, which may provide a video broadcast website, such as for all videos, performance videos, etc.

If the production computing device 102 broadcasts the video as a television broadcast, the viewer may access the video via a television. The television may be coupled to the content viewer computing device 110, such as a set-top box for receiving and decoding the broadcast signals and/or communicating with the social network device 106 and/or the remote computing device 108. Similarly, in embodiments were the production computing device 102 broadcasts the video via a computing network, such as the internet, the production computing device 102 may format and send the video to the social network device 106 and/or the remote computing device 108. In such embodiments, the production computing device that may be embodied as a personal computer, laptop computer, tablet, mobile computing device, and/or other device for accessing and displaying the video.

It should be understood that while the production computing device 102 is depicted as a mobile computing device, the video capture device 104 is depicted as a handheld personal camera, and the social network device 106, the remote computing device 108, and the content viewer computing device 110 are depicted as personal computers and/or servers, these are merely examples. In some embodiments, the production computing device that may be any type of mobile video production center and/or computing device for providing the functionality described herein. Similarly, the video capture device 104 may be any device for capturing, formatting, and/or sending video and/or audio content. The social network device 106, remote computing device 108, and the content viewer computing device 110 may be any type of computing device (e.g. mobile computing device, personal computer, server, set-top box, etc.). Additionally, while each of these devices 102-110 is depicted in FIG. 1 as single pieces of hardware, this is also an example. Each of the devices 102-110 may represent a plurality of cameras, microphones, speakers, computers, servers, databases, set-top boxes, etc.

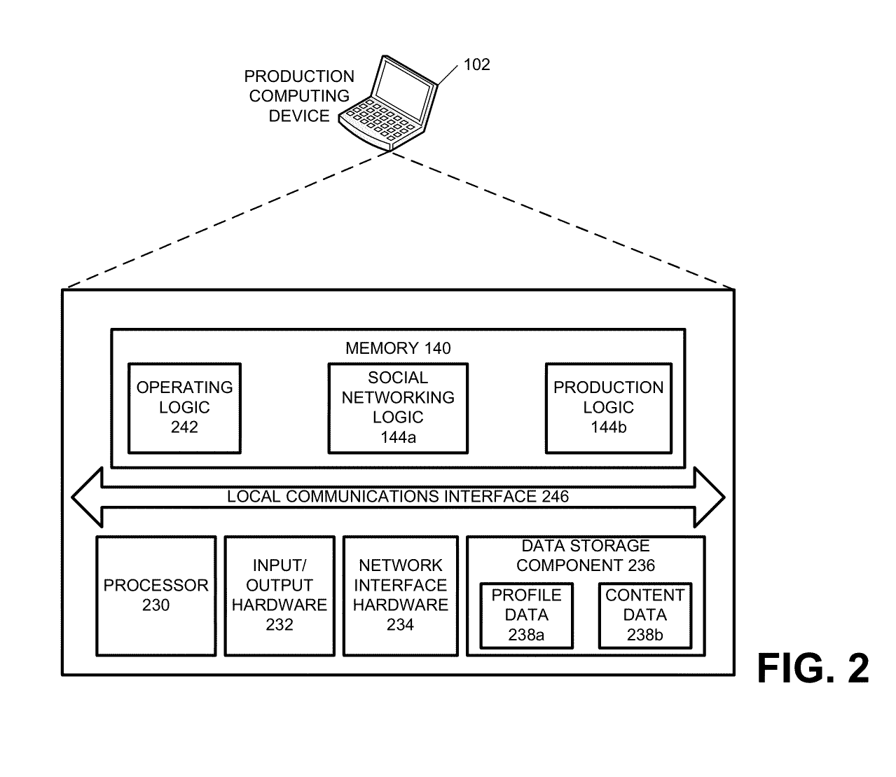

FIG. 2 depicts the production computing device 102 for providing a graphic for a video production, according to one or more embodiments shown and described herein. In the illustrated embodiment, the production computing device 102 includes a processor 230, input/output hardware 232, network interface hardware 234, a data storage component 236 (which stores profile data 238a and content data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the production computing device 102 and/or external to the production computing device 102.

Additionally, the memory component 140 may be configured to store operating logic 242, the social networking logic 144a, and the production logic 144b, each of which may be embodied as a computer program, firmware, and/or hardware, as an example. A local communications interface 246 is also included in FIG. 2 and may be implemented as a bus or other interface to facilitate communication among the components of the production computing device 102.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the production computing device 102 and other computing devices.

Similarly, it should be understood that the data storage component 236 may reside local to and/or remote from the production computing device 102 and may be configured to store one or more pieces of data for access by the production computing device 102 and/or other components. In some embodiments, the data storage component 236 may be located remotely from the production computing device 102 and thus accessible via the network 100. In some embodiments however, the data storage component 236 may merely be a peripheral device, but external to the production computing device 102.

Included in the memory component 140 are the operating logic 242, the social networking logic 144a and the production logic 144b. The operating logic 242 may include an operating system and/or other software for managing components of the production computing device 102. Similarly, the profile logic 144a may be configured to cause the production computing device 102 to create a social network. As discussed in more detail below, a social network may provide users with options for creating a group profile, a participant profile, as well as options for the participant profile to be linked to one or more group profiles, such as part of a sports team. The social network may additionally provide content regarding the group and/or participant such as audio, video, and/or text related to games and/or other events of the group and/or participant. Additionally, production logic 144b may reside in the memory component 140 and may be configured to cause the processor 230 to receive content from the content viewer computing device 110, as well as provide the content to other content viewer computing devices.

It should be understood that the components illustrated in FIG. 2 are merely exemplary and are not intended to limit the scope of this disclosure. While the components in FIG. 2 are illustrated as residing within the production computing device 102, this is merely an example. In some embodiments, one or more of the components may reside external to the production computing device 102. It should also be understood that, while the production computing device 102 in FIGS. 1 and 2 is illustrated as a single system, this is also merely an example. In some embodiments, the content providing functionality is implemented separately from the advertisement functionality, which may be implemented with separate hardware, software, and/or firmware.

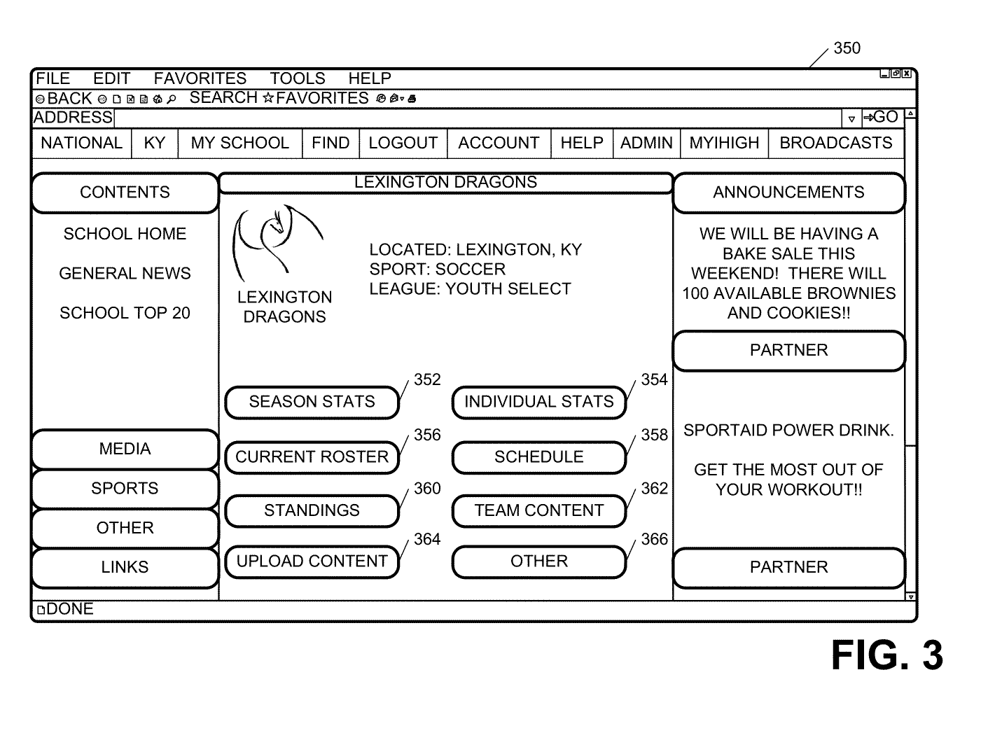

FIG. 3 depicts a user interface for providing a group page on a social network, according to one or more embodiments shown and described herein. As illustrated, the user interface 350 may be a first tier of the social network and may be provided in response to a user performing a keyword search for “Lexington Dragons” in the user interface 350 (FIG. 3). Similarly, the user interface 350 may be provided in response to selecting the season stats option 352 and otherwise navigating to the user interface 350. The user interface 350 may include information about the “Lexington Dragons,” which may be a sports team, drama cast, musical group, and/or other type of performance group. Accordingly, the user interface 350 may include a season stats option 352, an individual stats option 354, a current roster option 356, a schedule option 358, a standings option 360, a team content option 362, an upload content option 364, and an other option 366.

More specifically, by selecting the season stats option 352, the content viewer may be provided with one or more season performance statistics for the Lexington Dragons as a group. The individual stats option 354 may be configured to provide performance statistics for specific participants that are part of the group. The current roster option 356 may be configured to provide the content viewer with the current roster of the group. The schedule option 358 may provide the content viewer with a listing of events (such as games for the Lexington Dragons) that are occurring in the near future. The standings option 360 may provide standings for the league that the group is a member. The team content option 362 may provide options to view and/or identify content associated with the group. The upload content option 364 may provide options to upload, view, and/or identify action within the content, as described in more detail below. The other option 366 may provide other options related to the group.

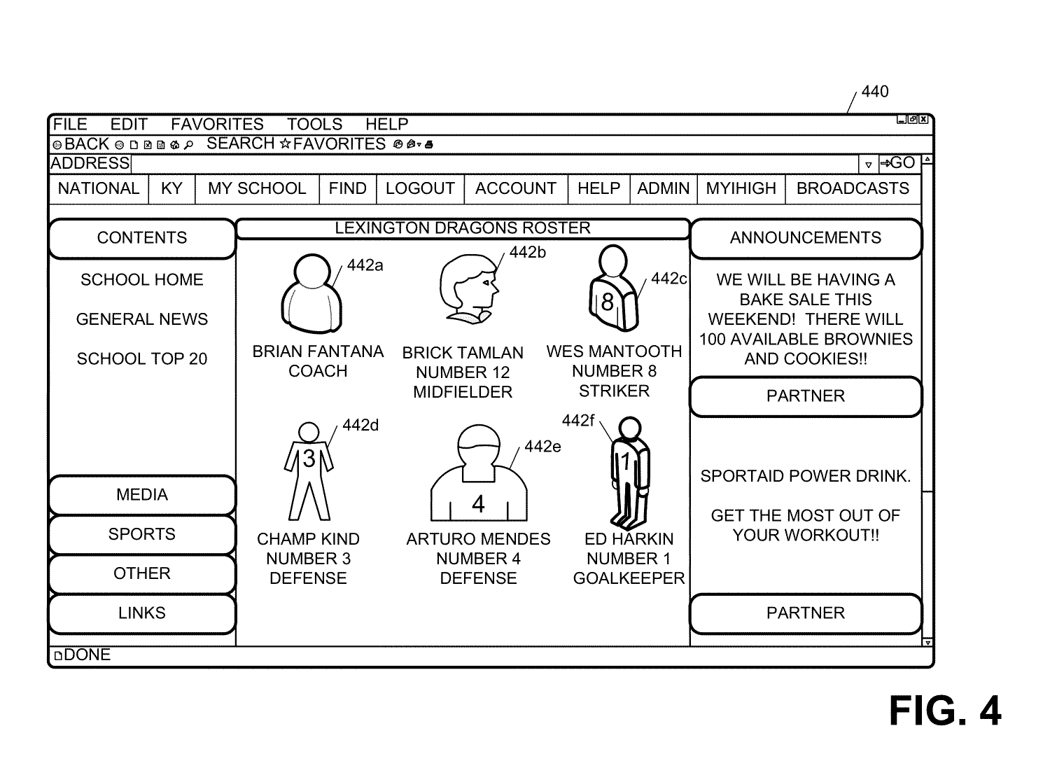

FIG. 4 depicts a user interface for providing a roster of participants, according to one or more embodiments shown and described herein. As illustrated, in response to selecting the current roster option 356 from FIG. 3, the user interface 450 may be provided with a listing of participants 452a-452f that are a part of the group. In the example of FIG. 4, the Lexington Dragons is a soccer team and the participants include a coach 452a, a midfielder 452b, a striker 452c, a first defender 452d, a second defender, and a goalkeeper 452f. The coach (or other entity) may be the administrator of the Lexington Dragons' profile and may thus determine the layout, the participants, the content, etc. that are provided on the profile. In some embodiments, the administrator may additionally have rights to control the content and layout of the individual participant profiles that are associated with the group.

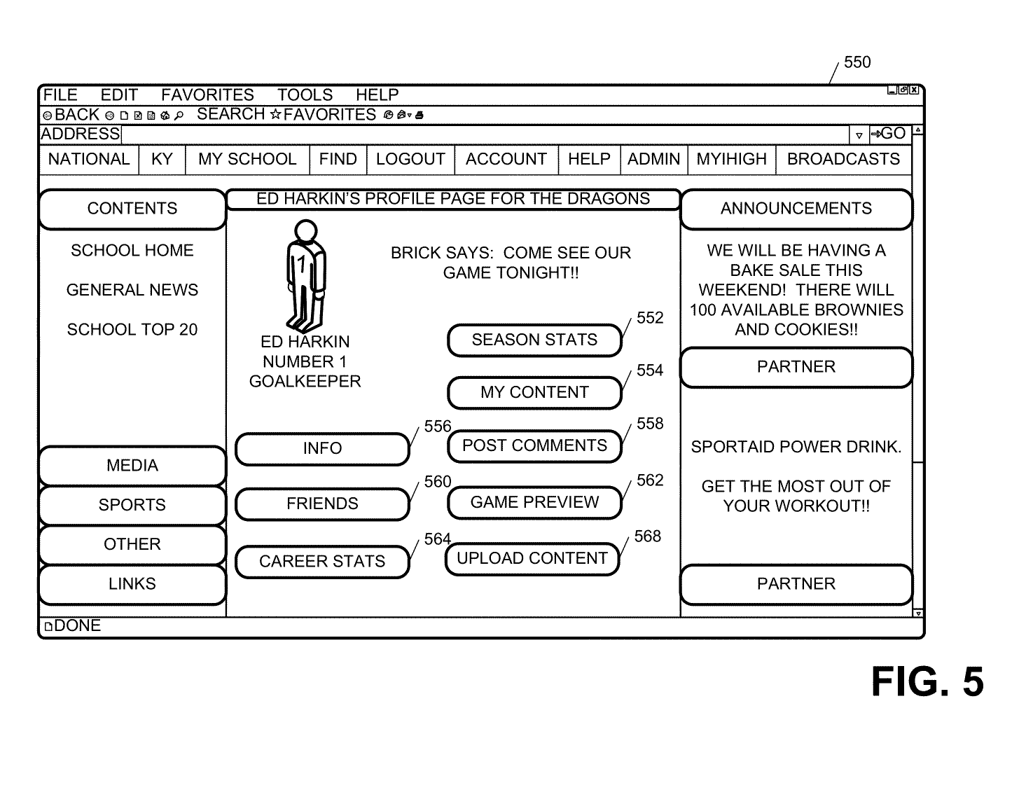

FIG. 5 depicts a user interface for providing a participant profile, according to one or more embodiments shown and described herein. As illustrated, the user interface 550 may be configured as a second tier of the performance social network and may be provided in response to selection of the goalkeeper 452f from FIG. 4. The user interface 550 may include a season stats option 552, a my content option 554, an info option 556, a post comments option 558, a friends option 560, a game preview option 562, a career stats option 564, and an upload content option 568.

More specifically, in response to selection of the season stats option 552, the content viewer may be provided with individual season performance statistics of the participant of the user interface 550. In response to selection of the my content option 554, the content viewer may be provided with imagery, audio content, video content, etc. of the participant. In response to selection of the info option 556, the content viewer may be provided with information about the participant. In response to selection of the post comments option 558, the content viewer may be provided with additional options to post comments for others to view. In response to selection of the friends option 560, the content viewer may be provided with a listing of “friends” of the participant on the performance social network. In response to selection of the game preview option 562, the content viewer may be provided with information regarding the participant's next game. Information, such as trends, historical data, predictions, etc. may be provided. In response to selection of the career stats option 564, the content viewer may be provided with career statistics for the participant. In response to selection of the upload content option 568, the content viewer may be provided with an option to upload, view, and/or identify content.

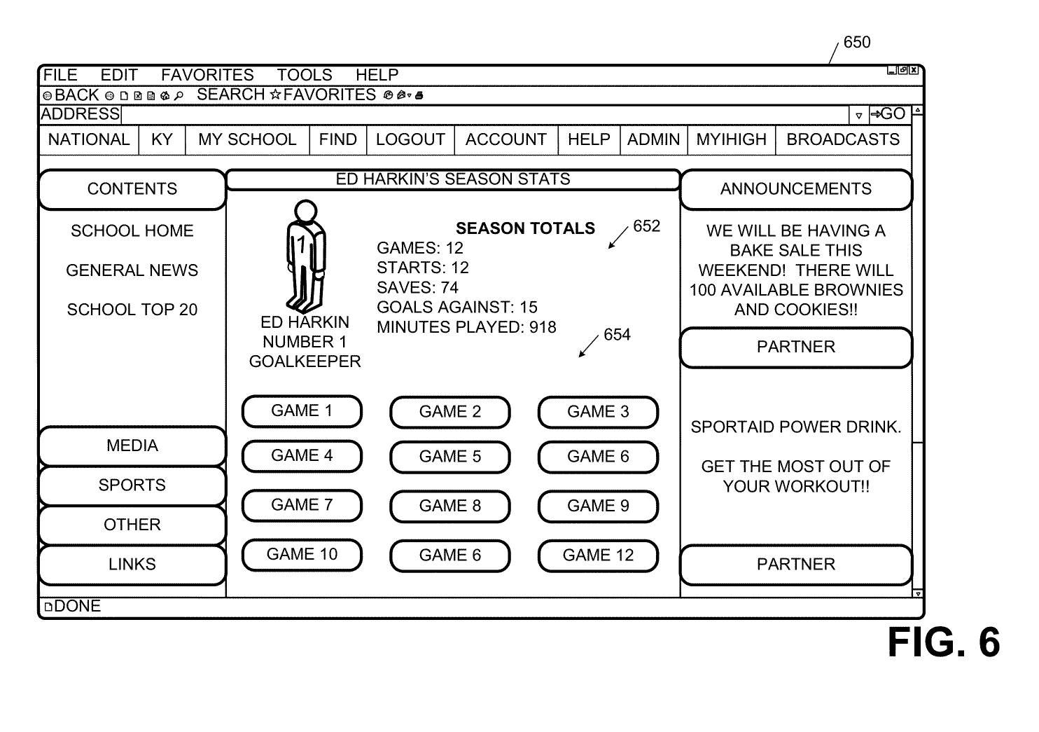

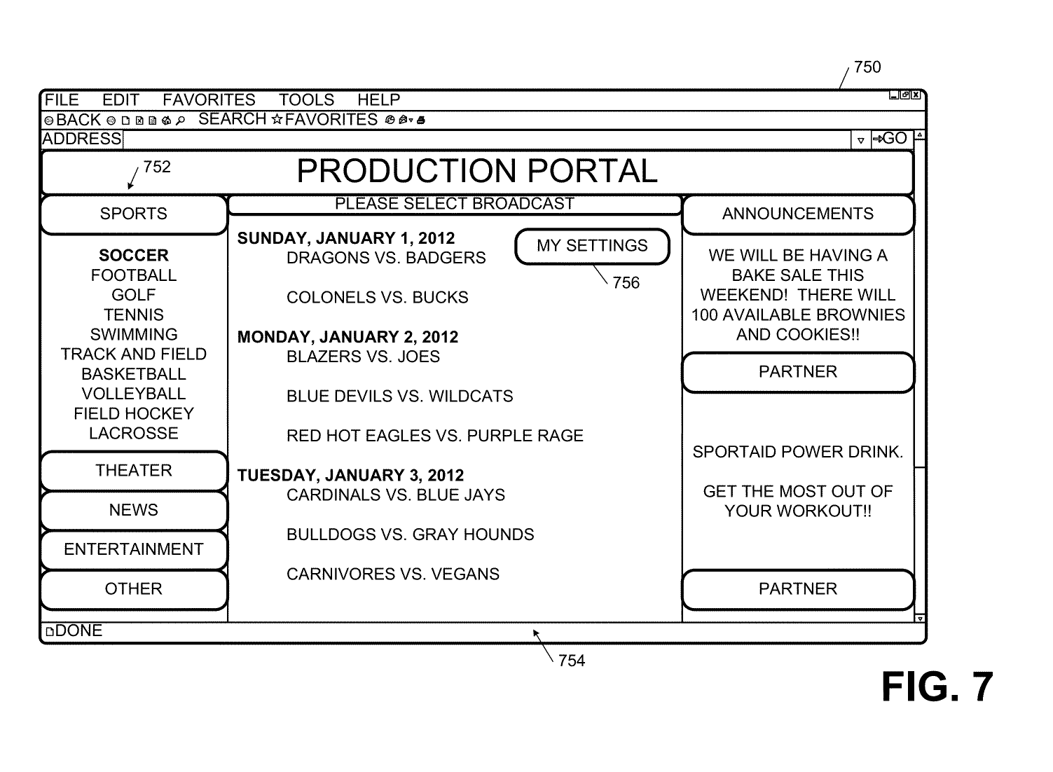

FIG. 6 depicts a user interface that provides a participant profile in a performance social network, according to one or more embodiments shown and described herein. As illustrated, in response to the season stats option 552 in FIG. 5, the user interface 650 may be provided. Additionally, the user interface 650 may include a season stats area 652 and a game option area 654. The season stats area 652 may include cumulative statistics for the participant over a season (or other designated time period). While the statistics may be manually entered, in some embodiments, the statistics may be determined based on tagged data described above. More specifically, when a production computing device user identifies Ed Harkin as making a save, as described with reference to FIGS. 7-10, the performance social network may additionally update Ed Harkin's season statistics (and game statistics) in the user interface 1050. Further, by selecting one of the game options, in-game statistics may be provided in a similar manner.

It should be understood that while the specific embodiments depicted in FIGS. 3-6 are directed to a performance social network, embodiments disclosed herein are not so limited. As an example, the production portal may be configured for communicating with any type of social network, where users of the social network provide personal information. Regardless of whether the social network is a performance social network or other type of social network, the performance portal may be configured to automatically utilize information from the social network in the production and/or update information on the social network as a result of the production.

FIG. 7 depicts a user interface 750 that provides a production portal for producing one or more events, according to embodiments shown and described herein. As illustrated, a production computing device user may log into the production portal to provide production features to viewer. Upon authenticating the production computing device user, the user interface 750 may be provided, which includes a plurality of options. Specifically, the user interface 750 includes an event type section 752 and an event listing section 754. The event type section 752 lists the types of events that are available for production. As an example, under the “Sports” heading, options for soccer, football, golf, tennis, swimming, track and field, basketball, volleyball, field hockey, and lacrosse are provided. By selecting one of these options, specific events relating to that event type may be provided. Other event types include theater, news, entertainment, and other. Still other event types may be provided in the user interface 750.

In the event listing section 754, a plurality of events may be provided that relate to the selected event type. As illustrated in FIG. 7, the “Soccer” heading was selected as the event type in the event type section 752. Accordingly, one or more soccer events are provided in the event listing section 754. In response to selection of one of the events listed in the event listing section 754, production options may be provided, as described in more detail below.

Also included in the user interface 750 is a “my settings” option 756. The my settings option 756 may provide additional settings and/or options related to production features that the production computing device user desires to utilize for a production.

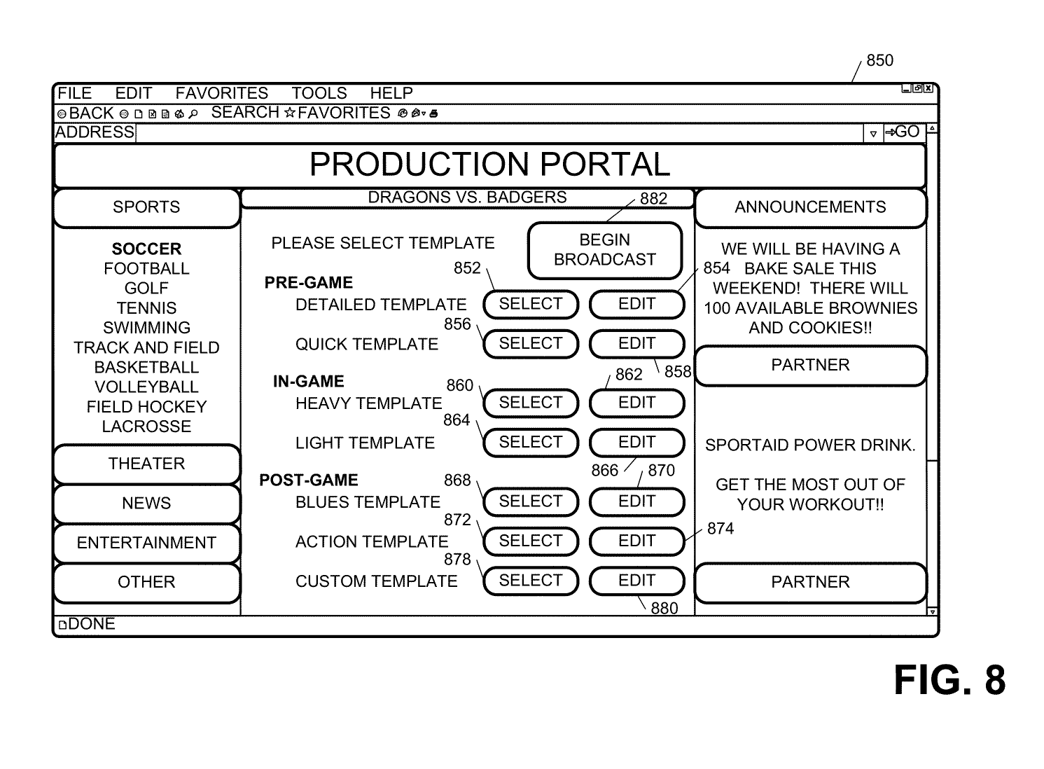

FIG. 8 depicts a user interface 850 for selecting and/or editing production templates of a broadcast, according to embodiments shown and described herein. As illustrated, the user interface 850 may be provided in response to selection of the Dragons vs. Badgers option from FIG. 7. Included in the user interface 850 are one or more production options, such as pre-game options, in-game options, and post-game options. The pre-game options may include a detailed template select option 852, a detailed template edit option 854, a quick template select option 856, and a quick template edit option 858. More specifically, embodiments disclosed herein may be configured to provide one or more production templates to a video broadcast. The templates may provide various features that provide consistent graphics for a broadcast. Accordingly, in FIG. 8, the production computing device user may be provided with a detailed template and a quick template. These templates may have been specifically created by the production computing device user and/or provided by a third party. Regardless, by selecting the detailed template select option 852, the detailed template may be implemented for this event. If the production computing device user wishes to view and/or edit the specifics of the detailed template, he may select the detailed template edit option 854.

Similarly included in the user interface 850 are in-game options, such as a select options 860, 864 and edit options 862, 866. Post-game options may also be provided, such as select options 868, 872, and 878 and edit options 870, 874, and 880. A begin broadcast option 882 may also be provided for beginning the broadcast.

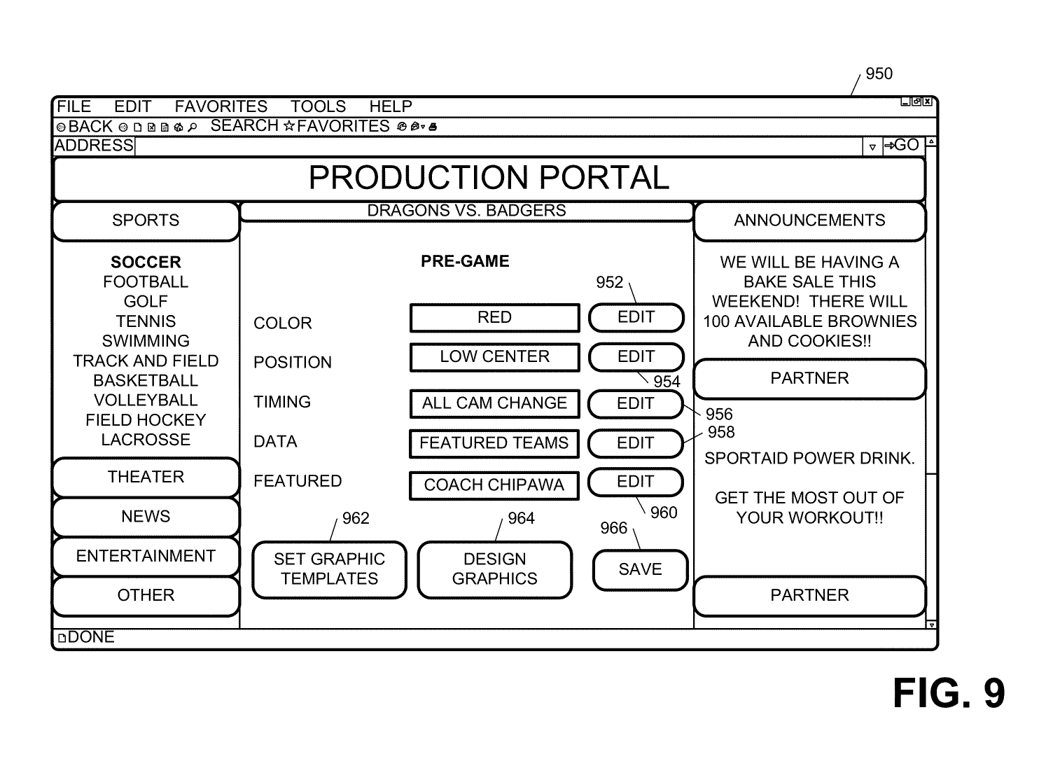

FIG. 9 depicts a user interface 950 for editing a pre-game production template, according to embodiments shown and described herein. In response to selection of the detailed template edit option 854 from FIG. 8, the user interface 950 may be provided to the production computing device user. The user interface 950 includes a colors option 952, a position option 954, a timing option 956, a data option 958, a featured persons option 960, and/or other options related to the pre-game broadcast More specifically, the colors option 952 and the position option 954 may define the presentation of in-game graphics of statistics and/or other data. The timing option 956 may define when the graphics, sound, and/or other production features are provided. In some embodiments, the options may include camera changes, predetermined timed intervals, upon returning from a commercial, and/or at other times.

Similarly, the data option 958 may be configured to provide options for the production computing device user to determine what types of data may be utilized. In some embodiments, the data option 958 may include one or more sources (such as the performance social network, a statistical database, etc.). Similarly, in some embodiments, the source may be determined and the data option 958 is utilized to determine the subject matter of the data that will be provided in the production. The data option 958 may be utilized to specifically identify a featured person, group, and/or subject for the pre-game production. By identifying a particular entity in the data option 958, statistics, video data, audio data, image data, and/or other data may be configured and provided in the pre-game production.

Also included in the user interface 950 is a set graphic templates option 962, a design graphics option 964, and a save option 966. The set graphic templates option 962 may provide the production computing device user with one or more options for further configuring the graphic templates, creating additional graphic templates, deleting graphic templates, and/or otherwise configuring templates for inclusion into a production. In response to selection of the design graphics option 964, the production computing device user and/or other person may design and/or configure graphics, audio, and/or other data for the production. More specifically, while the graphics and other data may be configured “on the fly” with the live video broadcast, other timing, content, and coordination may be configured prior to the broadcast. The save option 966 may save the selected settings.

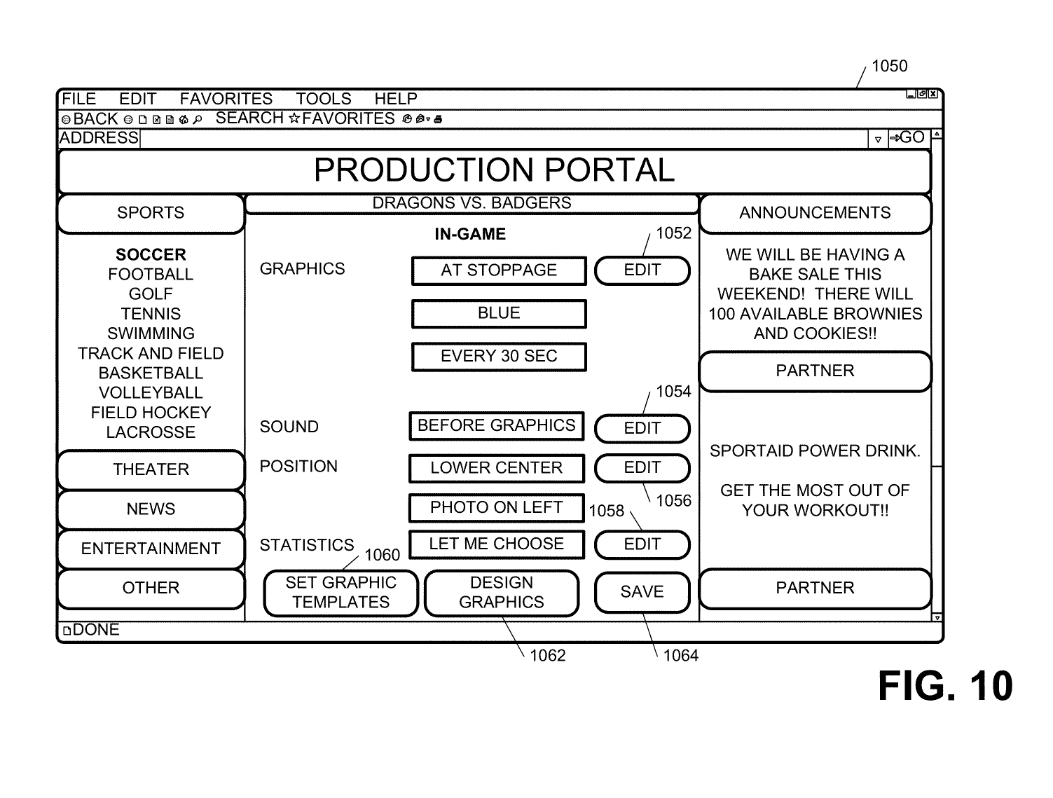

FIG. 10 depicts a user interface 1050 for editing an in-game production template, according to embodiments shown and described herein. In response to selection of one of the in-game edit options 862, 866 from FIG. 8, the user interface 1050 may be provided. Included in the user interface 1050 are options for setting graphics, sound, position, statistics, and/or other content for the video broadcast. As an example, the selected template provides that graphics are always provided at a game stoppage. Also according to the template, the graphics are blue and occur every 30 seconds. An edit option 1052 may be provided for adding, deleting, and/or editing the graphics portion of the in-game template.

Similarly, one or more options may be provided for including sound into the in-game production. The sound may be a predetermined sound effect and may be provided upon restarting play, after goal, upon a close-up of a particular player, and/or in response to other triggering action. These sound features of the production may be added, deleted, and/or edited in response to selection of an edit option 1054.

Similarly, position settings may also be provided that relate to the position of the graphic, the position of a participant photograph, the position of text, and/or other position effects. An edit option 1056 may also be provided for editing the position of various visual graphics and/or for changing the types positioning settings available. Statistics settings are also provided in the user interface 1050 for the production computing device user to select the statistics that are provided (or are available to be provided), the source of the statistics, the visual effect of the statistics (such as color, font, size, etc.), and/or other statistical settings. An edit option 1058 is also provided for editing the selected settings, adding additional settings, and/or deleting selected settings.

Also included in the user interface 1050 is a set graphic templates option 1060. More specifically, the production computing device user may desire to add additional graphic templates from those depicted in FIG. 8. The set graphic templates option 1060 may additionally provide options for editing the existing graphic templates and/or for providing other options. A design graphics option 1062 may also be provided, which may include options for the production computing device user to design the graphics themselves. As an example, embodiments disclosed above primarily detail the placement and timing of the graphics. However, the production computing device user (or other entity) may also design the graphics. Accordingly, the design graphics option 1062 may provide the forum for designing the graphics. In some embodiments, the design graphics option 1062 may merely open a portal to access previously created graphics. However, in some embodiments, the design graphics option 1062 may provide an interface for creating and/or editing a new graphic. A save option 1064 is also provided for saving the selected features.

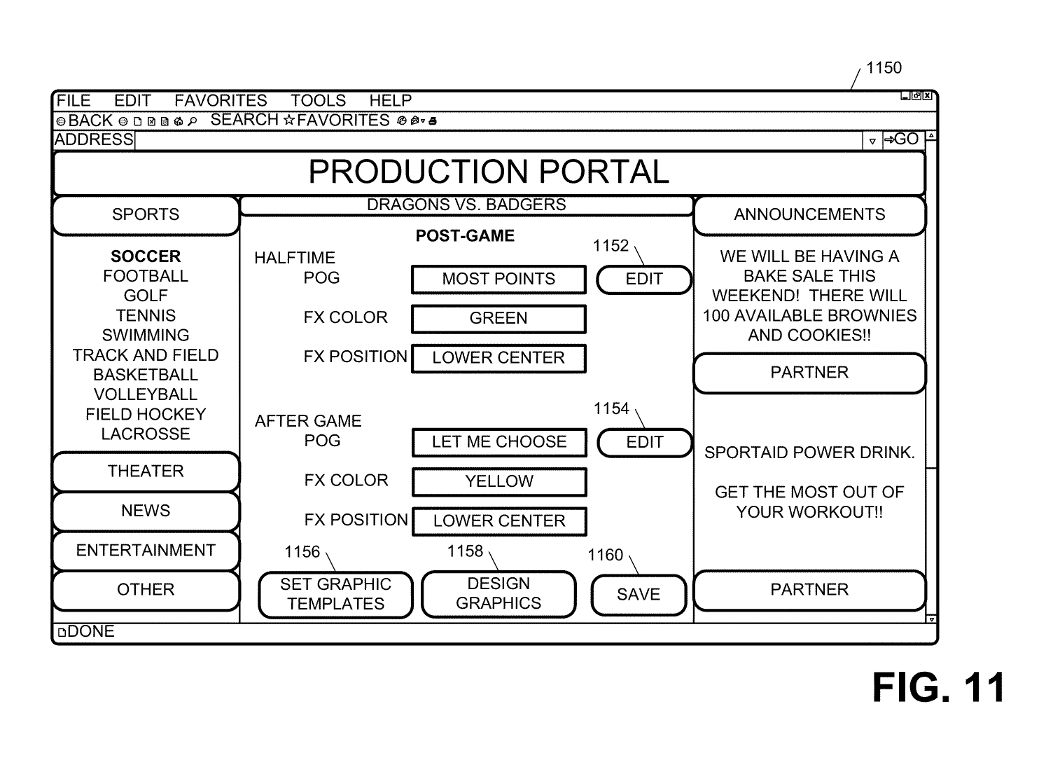

FIG. 11 depicts a user interface 1150 for editing a post-game production template, according to embodiments shown and described herein. In response to selection of one of the post-game edit options 870, 874, 880 from FIG. 8, the user interface 1150 may be provided. The user interface 1150 may include one or more halftime settings. The halftime settings may include a player of the game setting, an effects color setting, and an effects position setting. The player of the game setting may be configured for the production computing device 102 (FIGS. 1 and 2) to determine the participant to highlight at halftime of the event. While in some embodiments, the highlighted participant of the event may be determined by the broadcaster or other human that is associated with the broadcast, in some embodiments, the production computing device 102 may automatically determine the halftime player of the game. Accordingly, the player of the game setting may be configured to highlight the primary in-game statistic that is used to automatically determine the highlighted participant of the event. While in the user interface 1150 “most points” have been selected as the primary performance statistic, in some embodiments, a plurality of different criteria may be utilized as an algorithm for selecting the halftime highlighted participant of the event.

Similarly, the effects color setting and the effects position setting may be utilized to provide production features to the halftime programming that is provided for the event. Oftentimes, commentators or other on-air personalities provide analysis of the event during the intermission. As such, the production features may include graphics, effects, sound, etc. Thus, the effects color setting and the effects position setting provide these production features. An edit option 1152 may be provided for adding, editing, and/or deleting these and/or other settings utilized for the halftime production.

Similarly, after game production features may also be configured in the user interface 1150. More specifically, a player of the game setting, an effect color setting, and an effects position setting are provided. Similar to the settings provided above for halftime, these settings may provide production features during a post-game broadcast. An edit option 1154 is also provided for adding, deleting, and/or editing the settings provided for the after game broadcast.

Also included is a set graphic templates option 1156, a design graphics option 1158, and a save option 1160. Similar to the options 1060, 1062, and 1064 from FIG. 10, selection of these options may provide the production computing device user with other options for setting the templates, designing the graphics, and/or saving the current settings.

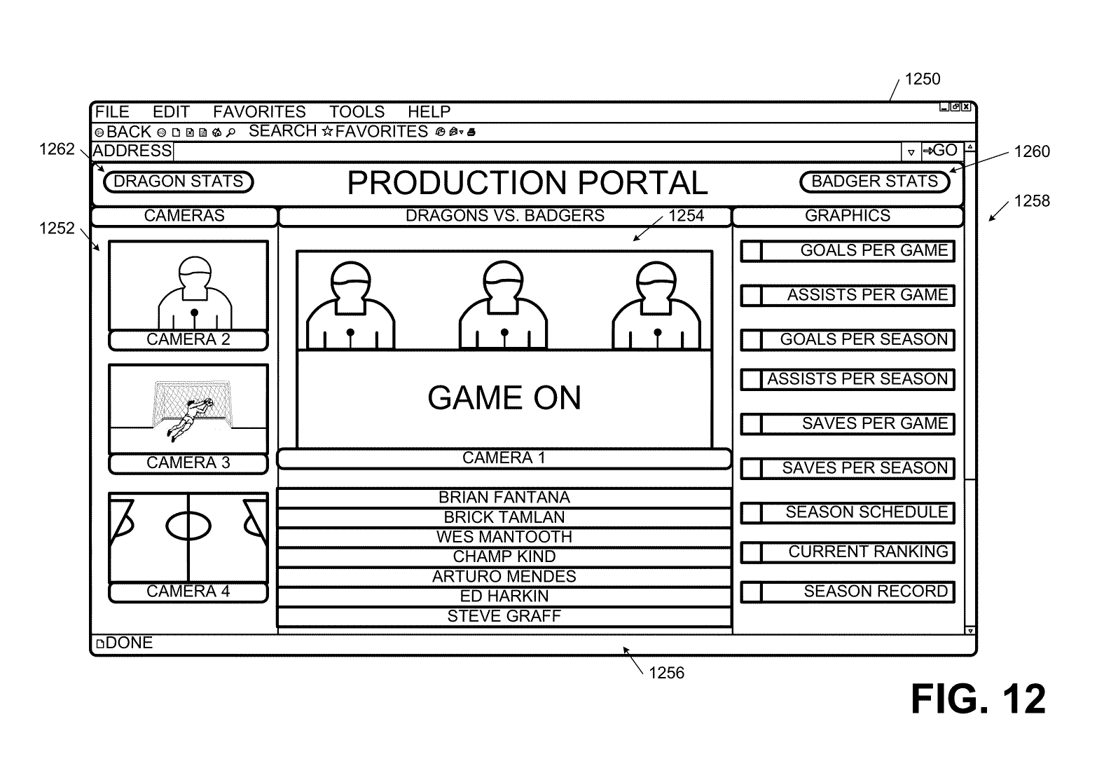

FIG. 12 depicts a user interface 1250 for providing a graphic for a video production, according to embodiments shown and described herein. In response to selection of the begin broadcast option 882 (FIG. 8), the broadcast may commence with the production computing device user being provided with video and/or audio feeds from one or more video capture devices 104. Accordingly, the user interface 1250 includes a cameras frame 1252 that provides video and/or audio feeds from one or more video capture devices 104. By selecting an image in the cameras frame 1252, that video and/or audio feed will be provided for broadcast in a broadcast frame 1254. The broadcast frame 1254 may provide the audio and/or video feeds that are being broadcast to one or more viewers. Also included is a graphics frame 1258 that provides one more templated graphics to include in the broadcast. A participant frame 1256 is also provided for identifying a participant to include in the broadcast graphic. Also included are statistics options 1260, 1262 for viewing statistics of participants that are involved in the event. The statistics may be retrieved from the performance social network and/or from other sources.

As an example, the on-air personalities depicted in the broadcast frame 1254 may be discussing a particular participant. Accordingly, the production computing device user may select a goals per game templated graphic to include into the broadcast. Additionally, by selecting one or more participants from the participant frame, the production computing device 102 may access statistical and/or other data for that user that corresponds to the selected templated graphic. The statistical and/or other data may be retrieved from the performance social network, as described above.

It should be understood that while the example of FIG. 12 depicts options that may be included in the broadcast “on the fly,” this is merely an example. In some embodiments, at least a portion of the broadcast may be scripted and thus the production features, such as graphics, statistics, sounds, etc. may be scripted, as well. As such, the options provided in FIG. 12 for scheduling at a future time, based on the predetermined script.

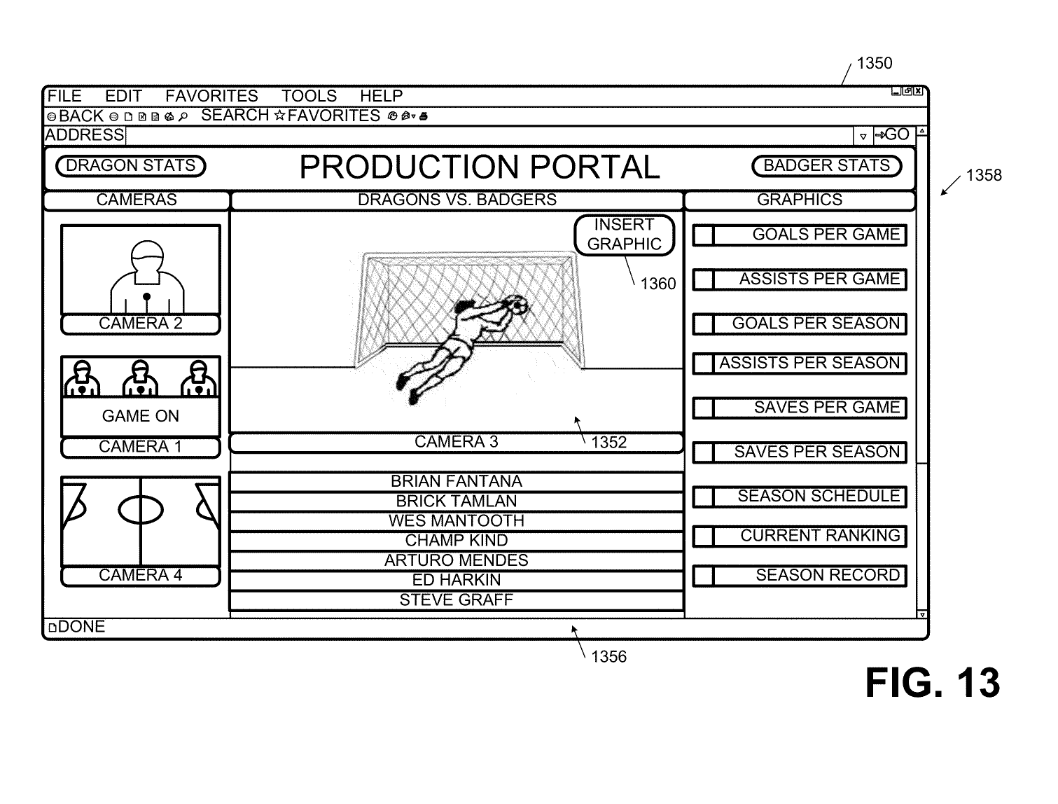

FIG. 13 depicts a user interface 1350 for providing a graphic for a video production, according to embodiments shown and described herein. In response to selecting one of the audio and/or video feeds in the cameras frame 1252, from FIG. 12, the broadcast frame may change to broadcast the selected audio and/or video feed. Additionally, because the event is broadcast in real time (live) or quasi-real time (with a slight delay from live), the production computing device user may schedule the graphics for inclusion when a particular participant is shown in the broadcast frame.

As an example, in the user interface 1350, the broadcast frame 1352 is broadcasting a save that was made by Ed Harkin. As this play developed, the production computing device user may anticipate that a save will be made and/or that a goal will be scored. As such, the production computing device user may select the saves per game option from a graphics frame 1358. The production computing device user may additionally select Ed Harkin from the participant frame. After Ed makes the save, the production computing device user may select an insert graphic option 1360 to provide a graphic with Ed Harkin's average saves per game. This information and/or a photo of Ed Harkin may be retrieved from Ed Harkin's profile on the performance social network. Additionally, because Ed Harkin recorded another save, the production computing device 102 can send an update to Ed Harkin's performance statistics on the performance social. Thus, a viewer that accesses Ed Harkin's (and/or the Dragon's) profile on the performance social network can see up-to-date performance statistics on the performance social network.

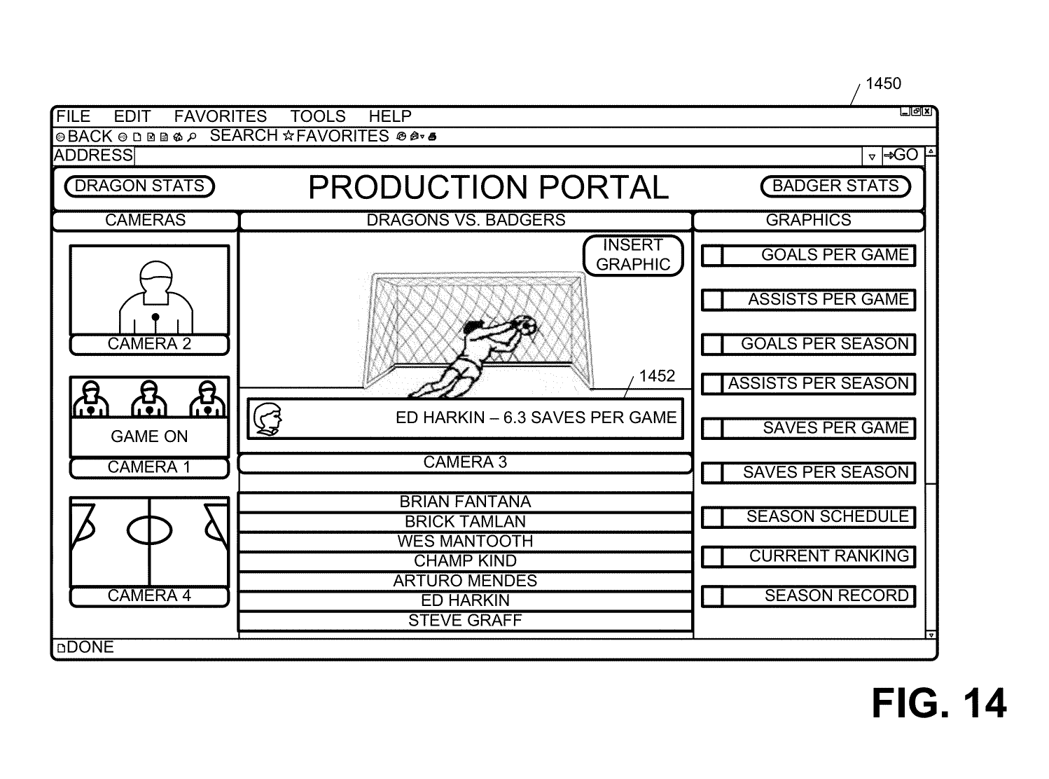

FIG. 14 depicts a user interface 1450 that depicts a graphic that is included in a video production, according to embodiments shown and described herein. As illustrated, in response to selection of the insert graphic option 1360, a graphic 1452 may be provided in the broadcast. As also discussed above, the image of Ed Harkin, as well as the selected statistic may be provided in the graphic 1452.

It should be understood that while the examples described with reference to FIGS. 13 and 14 depict an embodiment where the production computing device user may select a single participant and a single statistic for including in the graphic 1452, this is merely an example. In some embodiments, the production computing device user may create a plurality of different graphics, such that as a play develops, the production computing device user can simply select a graphic according to the end result of the play. Referring to the previous example, if the production computing device user determines that either a goal or a save will likely occur, the production computing device user may select the saves per game graphic and Ed Harkin for the first option and a goals per game graphic and a second participant for another graphic. Based on the eventual outcome of the play, the production computing device user can select either of the graphics to include in the broadcast.

It should also be understood that while the production computing device user may select a participant's name in the user interfaces 1350, 1450 (FIGS. 13 and 14) for inclusion of statistics and/or other data in a graphic, this is merely an example. More specifically, in some embodiments, the production computing device user may input a jersey number and/or the production computing device 102 (FIG. 1) may include recognition logic for automatically recognizing the participant who is participating in a particular play. Other embodiments are also considered.

In still further embodiments, the production computing device 102 (FIG. 1) may be configured to determine a point of action in the event and automatically update team and/or individual statistics accordingly. As an example, the production computing device 102 may receive in-game updates via a communication with a scoreboard output, via video recognition, via inputs from the production computing device user, and/or from other sources.

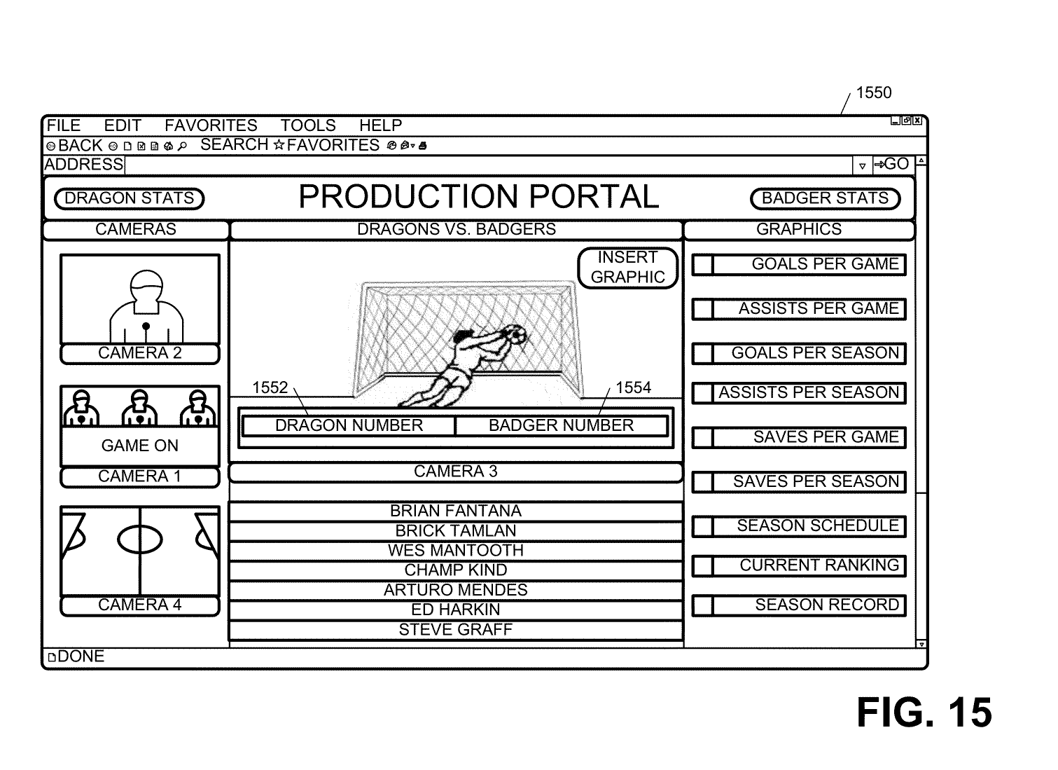

FIG. 15 depicts a user interface 1550 that provides additional options for providing a graphic for a video production, according to embodiments shown and described herein. As illustrated, in addition to a list of participants, the user interface 1550 includes an identifier option for each of the teams that are participating in the event. More specifically a first identifier option 1552 may be provided for the production computing device user to enter a jersey number (or other identifier) of a player on the Dragons. An identifier option 1554 may similarly be provided for the production computing device user to enter a jersey number (or other identifier) of a player on the Badgers.

Regardless, referring to the example above, as Ed Harkin is making a save, the production computing device user may select the first identifier option 1552 and input “1” to identify Ed Harkin. The production computing device user may additionally select a saves per season graphic, as well as an insert graphic option. In response, the production computing device 102 (FIG. 1) may retrieve the desired statistic and/or other data from the performance social network and insert the graphic, statistic, and/or other data into the broadcast.

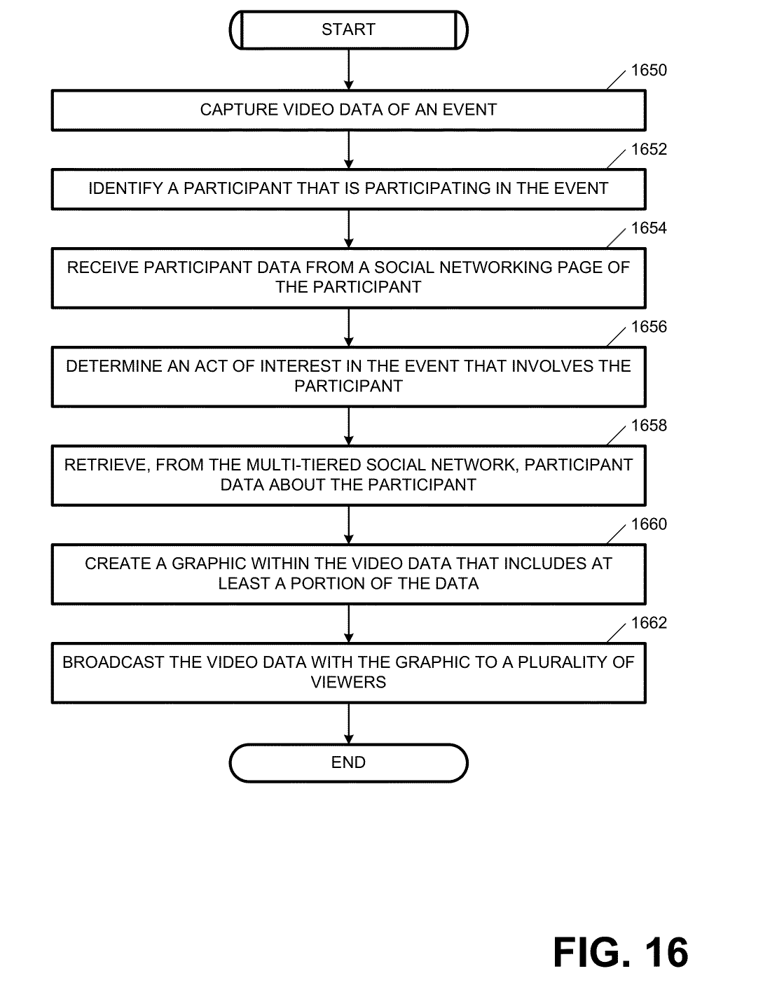

FIG. 16 depicts a flowchart for providing a graphic for a video production, according to embodiments shown and described herein. As illustrated n block 1650, video data of an event may be captured. In block 1652, a participant that is participating in the event may be identified. In block 1654, participant data may be received from a social networking page of the participant. In block 1656, an act of interest in the event may be determined that involves the participant. In block 1658, data on the participant may be retrieved from the multi-tiered social network. In block 1660, a graphic may be created within the video data that includes at least a portion of the participant data. In block 1662, the video data may be broadcast to a plurality of viewers, where the video data includes the graphic.

Embodiments disclosed herein provide systems and methods for identifying portions of content and linking those portions to a social network. Accordingly, the portions of content may be provided via tags and/or metadata that references portions of the content such that the portions of content may be dynamically provided without greatly affecting overall storage requirements. Further, the information provided in the tags may be additionally linked to the social network for updating statistics and/or providing other information.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing a graphic for a video production, comprising:
capturing video data of an event;
identifying a participant that is participating in the event;
receiving participant data from a social networking page of the participant, the social networking page being part of a multi-tiered social network;
determining an act of interest in the event that involves the participant;
retrieving, from the multi-tiered social network, participant data about the participant;
creating, by a computing device, a graphic within the video data that includes at least a portion of the participant data; and
broadcasting the video data with the graphic to a plurality of viewers.

2. The method of claim 1, further comprising:
determining an in-game statistic for the event; and
updating the multi-tiered social network with the in-game statistic.

3. The method of claim 1, further comprising:
determining an in-game statistic for the event;
providing an option to determine, based on the in-game statistic, a highlighted participant of the event;
in response to selection of the option, creating a graphic overlay for the video data that identifies the highlighted participant of the event;
retrieving data for the highlighted participant from the multi-tiered social network; and
providing the graphic overlay in the video data.

4. The method of claim 1, wherein the computing device is physically located in proximity with the event.

5. The method of claim 1, wherein the event comprises at least one of the following: a sporting event, a theatrical event, a news event, an entertainment event, and a scholastic event.

6. The method of claim 1, wherein the video data is broadcast via at least one of the following: television broadcast, the multi-tiered social network, and a video broadcast website.

7. The method of claim 1, wherein the multi-tiered social network includes a team profile page for a team as a first tier and the social networking page of the participant as a second tier, wherein the participant is a member of the team.

8. A system for providing a graphic for a video production, comprising:
a memory component that stores logic that, when executed by the system, causes the system to perform at least the following:
receive a live video of an event, the event involving a participant;
determine a point of action in the event;
receive an indication for inserting a graphic overlay in the live video, the graphic overlay identifying the participant;
accessing a participant profile page of the participant from a social network to retrieve a performance statistic of the participant;
include the performance statistic in the graphic overlay; and
broadcast the live video and the graphic overlay to a plurality of viewers.

9. The system of claim 8, wherein the point of action is determined from at least one of the following: a user input, a video recognition, and a scoreboard output.

10. The system of claim 8, wherein the social network is configured as a multi-tiered social network that provides a team page on a first tier of the social network and the participant profile page on a second tier of the social network.

11. The system of claim 8, wherein the logic further causes the system to perform at least the following:
determine an in-game statistic for the event; and
update the social network with the in-game statistic.

12. The system of claim 8, further comprising a production computing device that is located proximate the event.

13. The system of claim 8, wherein the logic further causes the system to perform at least the following:
calculate an in-game statistic for the event;
provide an option to determine, based on the in-game statistic, a highlighted participant of the event;
in response to selection of the option, create a different graphic overlay for the video data that identifies the highlighted participant of the event;
retrieve data for the highlighted participant from the social network; and
provide the graphic overlay in the video data.

14. A non-transitory computer-readable medium for providing a graphic for a video production that stores logic, that when executed by a computing device, causes the computing device to perform at least the following:
receive a live video of a sporting event, the sporting event involving a plurality of teams, the plurality of teams each including a participant;
determine a point of action in the sporting event;
receive an indication for inserting a graphic overlay in the live video, the graphic overlay identifying the participant from at least one of the plurality of teams;
access a participant profile page of the participant from the at least one of the plurality of teams, the participant profile page being accessed from a performance social network to retrieve a performance statistic of the participant;
include the performance statistic in the graphic overlay; and
broadcast the live video and the graphic overlay to a plurality of viewers.

15. The non-transitory computer-readable medium of claim 14, wherein the point of action is determined from at least one of the following: a user input, a video recognition, and a scoreboard output.

16. The non-transitory computer-readable medium of claim 14, wherein the performance social network is configured as a multi-tiered performance social network that provides a team page on a first tier of the performance social network and the participant profile page on a second tier of the performance social network.

17. The non-transitory computer-readable medium of claim 14, wherein the logic further causes the computing device to perform at least the following:
determine an in-game statistic for the sporting event; and
update the performance social network with the in-game statistic.

18. The non-transitory computer-readable medium of claim 14, wherein the logic further causes the computing device to perform at least the following:
calculate an in-game statistic for the sporting event;
provide an option to determine, based on the in-game statistic, a highlighted participant of the sporting event;
in response to selection of the option, create a different graphic overlay for the video data that identifies the highlighted participant of the sporting event;
retrieve data for the highlighted participant from the performance social network; and
provide the graphic overlay in the video data.

19. The non-transitory computer-readable medium of claim 14, wherein the computing device is in proximity of the sporting event and wherein the computing device receives video data from a camera at the sporting event for broadcasting.

20. The non-transitory computer-readable medium of claim 14, wherein the live video is broadcast via at least one of the following: broadcast television, the performance social network, and a video broadcast website.
